(19) United States
(12) Patent Application Publication
(10) Pub. No.: US 2025/0187984 A1
(43) Pub. Date: Jun. 12, 2025

(54) HYDRAULIC BINDER COMPOSITION COMPRISING BLAST FURNACE SLAG

(71) Applicant: CHRYSO, Courbevoie (FR)

(72) Inventors: Pascal BOUSTINGORRY, BREUILLET (FR); Marie DAVID, PITHIVIERS (FR); Laurent BONAFOUS, SEVRES (FR)

(21) Appl. No.: 18/844,833

(22) PCT Filed: Mar. 10, 2023
(86) PCT No.: PCT/EP2023/056109

§ 371 Date: Sep. 6, 2024

(30) Foreign Application Priority Data
Mar. 10, 2022 (FR) FR2202087

(51) Int. Cl. C04B 28/26; C04B 22/08; C04B 22/10; C04B 22/14; C04B 28/14; C04B 103/10

(52) U.S. Cl. CPC C04B 28/26; C04B 22/085; C04B 22/10; C04B 22/142; C04B 28/14; C04B 2103/10

(57) ABSTRACT

The present invention relates to a hydraulic binder composition comprising:
a hydraulic binder that comprises at least one alumino-silicate compound, preferably blast furnace slag, and an alkaline or sulphate activator, and a maximum of 10% by weight of clinker, preferably from 0 to 10% by weight of clinker;
nitric acid or a salt thereof, other than zinc nitrate.

The present invention relates to a hydraulic binder composition comprising at least one alumino-silicate compound, and an alkaline or sulphate activator, and a reduced amount of clinker, and to the retention of workability of the hydraulic composition obtained, in particular by the adding of water to the hydraulic binder composition.

Common cementitious compositions comprise a variable, sometimes high proportion of clinker. For example, a cementitious composition according to the French standard NF EN 197-1 of 2012 comprises from 5 to 95% by weight of clinker.

However, the manufacture of clinker requires the use of powerful kilns, thus resulting in the emission of large quantities of carbon dioxide. The extraction of raw materials is also a source for discharging carbon dioxide emissions.

It is therefore sought to lower the clinker content of cementitious compositions in order to reduce the carbon impact thereof, while however maintaining the mechanical and rheological properties thereof.

To this end, new hydraulic binder compositions have been developed in which the amount of clinker is reduced.

Cementitious compositions in which the hydraulic binder is an alumino-silicate compound, for example, a blast furnace slag have been previously disclosed, these compositions being generally activated. However, there is a very rapid drop in the workability of these compositions, which is to say that they go from a fluid to an almost solid state in less than 30 minutes. From a rheological standpoint, threshold stresses of 1 to 10 Pa are typically observed five minutes after mixing, with the values increasing to 50 to 100 Pa between 30 and 60 minutes after mixing.

There is therefore an interest in providing a solution which makes it possible to enhance the fluidity of compositions that comprise at least one alumino-silicate compound, preferably blast furnace slag.

One objective of the present invention is to provide a hydraulic binder composition comprising at least one alumino-silicate compound and an alkaline or sulphate activator which makes it possible to obtain a hydraulic composition that exhibits enhanced retention of fluidity.

Another objective of the present invention is to provide a hydraulic binder composition comprising at least one alumino-silicate compound and an alkaline or sulphate activator that exhibits good thixotropic properties and a good trade-off between thixotropic properties and mechanical strengths, in particular at 28 days.

Another objective of the present invention is to provide such a composition that serves to enable fluidity to be retained for a period of 1 hour or 1 hour and 30 minutes.

Other additional objectives will also become apparent upon reading the description of the invention which follows.

All of these objectives are achieved in the present patent application which relates to a hydraulic binder composition (HBC) comprising:
a hydraulic binder that comprises at least one alumino-silicate compound and an alkaline or sulphate activator, and a maximum of 10% by weight of clinker, preferably from 0 to 10% by weight of clinker;
nitric acid or a salt thereof, the salt of nitric acid being other than zinc nitrate.

In an advantageous manner the inventors have shown that the adding of nitric acid or a salt thereof, other than zinc nitrate, according to the invention provides the means for enhancing the retention of fluidity (also referred to as retention of workability) over time, of a hydraulic composition prepared from the hydraulic binder composition (HBC), in particular by adding at least water, as compared to a composition that does not contain nitric acid or a salt thereof according to the invention.

In the context of the present invention, the enhancement in the retention of workability, as measured, for example, by the evolving change in the threshold stress of a hydraulic composition obtained from the composition HBC, in particular by adding of water, over time, is preferably long-term, that is to say over a period greater than or equal to 45 minutes, in particular greater than 60 minutes, or indeed even greater than 90 minutes when the composition is used at 20° C. It is therefore desirable to have threshold stresses of the order of 1 to 10 Pa over the same time intervals, that is to say over a period greater than or equal to 45 minutes, in particular greater than 60 minutes, or indeed even greater than 90 minutes when the composition is used at 20° C.

The threshold stress may in particular be measured by means of a rheometer by performing a number of measurements of the stress applied in order to obtain each corresponding strain rate value. The value of applied stress below which the strain rate becomes very low or zero may be considered to be the threshold stress.

Thus, the inventors have shown that the use of nitric acid or a salt thereof, other than zinc nitrate, makes it possible to provide thixotropic properties to the hydraulic composition advantageously without significantly modifying the mechanical strengths, in particular the mechanical strengths at 28 days.

The hydraulic binder composition (HBC) may be free of clinker.

In the context of the present invention, the clinker may be Portland cement clinker, sulphoaluminate cement clinker or sulphobelite cement clinker.

In the context of the present invention, the term “alumino-silicate compound” is used to refer to blast furnace slag from pozzolanic materials (as defined in the French standard Cement NF EN 197-1(2012) paragraph 5.2.3), fly ash (as defined in the French standard Cement NF EN 197-1(2012) paragraph 5.2.4), calcined schists (as defined in the French standard Cement NF EN 197-1 (2012) paragraph 5.2.5), or even silica fumes (as defined in French standard Cement NF EN 197-1 (2012) paragraph 5.2.7) or the mixtures thereof. Other minerals not currently recognised by the French standard Cement NF EN 197-1(2012), may also be used. These include in particular metakaolins, such as type A metakaolins compliant with the French standard NF P 18-513 (August 2012), or calcined clays, siliceous additives, such as siliceous additives having quartz (Qz) mineralogy in compliance with the French standard NF P 18-509 (September 2012), alumino-silicates in particular of the inorganic geopolymer type, alumino-silicates containing iron oxides such as bauxite residues, norites or aplites obtained from excavations.

Preferably, the aluminum-silicate compound is selected from among blast furnace slags, pozzolanic materials (as defined in the French standard Cement NF EN 197-1(2012) paragraph 5.2.3), fly ash (as defined in the French standard Cement NF EN 197-1(2012) paragraph 5.2.4), calcined schists (as defined in the French standard Cement NF EN 197-1 (2012) paragraph 5.2.5), metakaolins, such as type A metakaolins compliant with the French standard NF P 18-513 (August 2012) or calcined clays, alumino-silicates in particular of the inorganic geopolymer type, alumino-silicates containing iron oxides such as bauxite residues, norites or aplites obtained from excavations.

The composition of the invention may comprise a mixture of alumino-silicate compounds.

Preferably, the hydraulic binder composition comprises from 75 to 99% by weight of alumino-silicate compound, preferably from 80 to 95% by weight, for example from 80 to 90% by weight, relative to the total weight of hydraulic binder.

In one embodiment, the hydraulic binder consists of an alumino-silicate compound and an alkaline or sulphate activator.

The hydraulic binder may also comprise mineral additives, in an amount preferably from 0 to 10% by weight relative to the total weight of hydraulic binder.

The term “mineral additives” is used to refer to pozzolanic materials (as defined in the French standard Cement NF EN 197-1 (2012) paragraph 5.2.3), calcined schists (as defined in the French standard Cement NF EN 197-1 (2012) paragraph 5.2.5), limestone (as defined in the French standard Cement NF EN 197-1 (2012) paragraph 5.2.6), or even silica fumes (as defined in the French standard Cement NF EN 197-1 (2012) paragraph 5.2.7), or mixtures thereof. Other additives, not currently recognised in the standard Cement NF EN 197-1 (2012), may also be used. These include silica additives, such as silica additives having quartz (Qz) mineralogy, compliant with the French standard NF P 18-509 (September 2012). The proportions of additives and the nature thereof may also comply with the European standard prEN 197-5, which defines Portland-composite cements CEM II/C-M comprising between 50 and 64% clinker and from 36 to 50% blast furnace slag, and composite cement CEM VI containing from 35 to 49% clinker, from 31 to 59% blast furnace slag furnace, and from 6 to 20% of mineral additives as defined above.

Preferably, the alumino-silicate compound is a blast furnace slag and the hydraulic binder may also comprise mineral additives.

Blast furnace slag is defined in particular in parts 3.7 and 3.6 of the French standard NF EN 15167-1. Blast furnace slag is a predominantly vitreous material and is a by-product of the cast iron production process. Blast furnace slags used in hydraulic binder compositions are finely ground, preferably to a maximum diameter of 100 to 150 μm, the diameter being measured by any suitable method known to the person skilled in the art, for example by laser granulometry. Blast furnace slags generally require calcium or sulpho-calcium activation or activation using a strong base.

The term “mineral additives” is used to refer to pozzolanic materials (as defined in the French standard Cement NF EN 197-1 (2012) paragraph 5.2.3), fly ash (as defined in the French standard Cement NF EN 197-1 (2012) paragraph 5.2.4), calcined schists (as defined in the French standard Cement NF EN 197-1 (2012) paragraph 5.2.5), limestone (as defined in the French standard Cement NF EN 197-1 (2012) paragraph 5.2.6), or even silica fumes (as defined in the French standard Cement NF EN 197-1 (2012) paragraph 5.2.7), or mixtures thereof. Other additives, not currently recognised in the standard Cement NF EN 197-1 (2012), may also be used. These include metakaolins, such as type A metakaolins compliant with the French standard NF P 18-513 (August 2012) or calcined clays; silica additives, such as silica additives having quartz (Qz) mineralogy, compliant with the French standard NF P 18-509 (September 2012); alumino-silicates, in particular of the inorganic geopolymer type. The proportions of additives and the nature thereof may also comply with the European standard prEN 197-5, which defines Portland-composite cements CEM II/C-M comprising between 50 and 64% clinker and from 36 to 50% blast furnace slag, and composite cement CEM VI containing from 35 to 49% clinker, from 31 to 59% blast furnace slag, and from 6 to 20% of mineral additives as defined above.

The hydraulic binder composition (HBC) of the invention comprises at least one alkaline or sulphate activator for alumino-silicate compounds, in particular blast furnace slags. These activators are known and described in particular in the context of Alkaline activation of different alumino-silicates as an alternative to Portland cement: alkali activated cements or geopolymers. [See eg Revista Ingeniería de ConstrucciónRICVol 32 No 22017]. Preferably the activator is a calcium or sulphate activator, preferably a sulpho-calcium activator; or an alkaline salt, preferably a sodium or potassium carbonate, hydroxide or silicate, or mixtures thereof; or a calcium sulphate activator. This activator is used preferably in proportions of from 0.1 to 20% by dry weight relative to the total weight of hydraulic binder, preferably from 1% to 20% by dry weight relative to the total weight of hydraulic binder.

Thus, the hydraulic binder composition may also include calcium sulphate, in particular in a proportion of 5 to 20% by weight. Such hydraulic binder compositions are also known as super-sulphated cement (SSC) and are in particular as defined in the French standard NF EN 15743+A1.

Preferably, the hydraulic binder comprises, and preferably, consists of a blast furnace slag, an activator, and 0 to 10% by weight of clinker.

Preferably, the hydraulic binder consists of a blast furnace slag and an activator as described above.

Preferably, the salts of nitric acid are salts of alkali or alkaline earth metals. Preferably, the salts of nitric acid are calcium or sodium salts, preferably calcium salts.

It is known practice to add calcium nitrate to Portland cement compositions in order to accelerate the setting of the hydraulic composition. It is a known practice to add calcium nitrate to Portland cement compositions in order to accelerate the setting of the hydraulic composition. In a surprising way, the inventors discovered that the addition of nitric acid or salts to systems that are based on blast-furnace slag and low in clinker (in particular less than 10% by weight of clinker) provided the means for fluidising them.

The amount of nitric acid or a salt thereof in the hydraulic binder composition (HBC) is between 0.1 and 5% by dry weight, preferably between 1.0 and 2.5% by dry weight, relative to the total weight of hydraulic binder.

Preferably, the amount of nitric acid or a salt thereof in the hydraulic binder composition (HBC) is between 0.1 and 1.5% by dry weight, relative to the total weight of hydraulic binder.

The hydraulic binder composition may also include a polymer (P) comprising units having the following formulae (I) and (II):

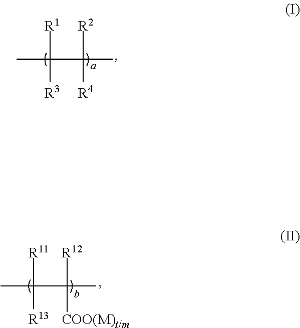

in which:
R¹ and R² independently represent a hydrogen or a methyl;
R³ represents a hydrogen or a group having the formula —COO(M)_{i/m};
R⁴ represents a group having the formula —(CH₂)ₚ—(OAlk)_{q}-R₅ in which:
p represents 1 or 2;
q represents an integer from 3 to 300;
the Alk of each OAlk unit of the group —(OAlk)_{q}-independently represents a linear or branched alkylene containing from 2 to 4 carbon atoms;
R⁵ represents —OH or a linear or branched alkoxyl containing from 1 to 4 carbon atoms;
R¹¹ and R¹² independently represent a hydrogen or a methyl;
R¹³ represents a hydrogen or a group having the formula —COO(M)_{1/m};
M represents H or a cation of valency m;
when M represents H, m represents 1, and when M represents a cation, m is the valency of the cation M;
a is a number from 0.05 to 0.25, such that (100×a) represents the molar percentage of units having the formula (I) within the polymer, and
b is a number from 0.75 to 0.95, such that (100×b) represents the molar percentage of units having the formula (II) within the polymer.

Preferably, the HBC composition comprises from 0.1 to 3.0% by dry weight of polymer (P), preferably from 0.3 to 1.0% by dry weight of polymer (P), relative to the total weight of hydraulic binder.

In the context of the present invention, the term “total weight of hydraulic binder” is used to refer to the weight of: the alumino-silicate compounds, the activator, the clinker if present, and the mineral additives if present.

The following embodiments for the formulae (I) and (II) of the units of the polymer (P) may be considered independently or combined together:
R¹ represents H;
R³ represents H;
R¹ and R³ represent H;
R² represents a methyl;
p represents 1;
Alk represents —CH₂—CH₂—, —CH₂—CH₂—CH₂—, —CH₂—CH₂—CH₂—CH₂—, —CH₂—CHMe-, —CHMe-CH₂—;
at least 80% of the Alks of the group —(OAlk)_{q}-represent —CH₂—CH₂—, or even all of the Alks of the group —(OAlk)_{q}-represent —CH₂—CH₂—;
q represents an integer from 5 to 200, in particular from 10 to 100, preferably from 25 to 75;
R⁵ represents —OH or —OMe, preferably R⁵ represents —OH;
the sum of a and b is 1;
R¹¹ represents H;
R¹³ represents H;
R¹¹ and R¹³ represent H;
R¹² represents H; and/or
M represents H or a monovalent or bivalent cation, with m then representing 1 or 2, the monovalent cation preferably being selected from among an ammonium salt NH4⁺, a primary, secondary, tertiary or quaternary ammonium cation and a cation of an alkali metal, such as a sodium, lithium or potassium ion, and the divalent cation preferably being a cation of an alkaline earth metal, such as a magnesium or calcium ion;
a is a number from 0.05 to 0.20, preferably a represents a number between 0.10 and 0.20;
b is a number from 0.80 to 0.95, preferably b represents a number between 0.80 and 0.90.

Preferably, the units having the formula (I) of the polymer (P) have the following formula (I′):

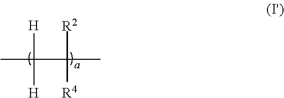

in which:
R² independently represents a hydrogen or a methyl, preferably a methyl;
R′⁴ represents a group having the formula —CH₂—(O—CH₂—CH₂)_{q}—R₅ in which:
q represents an integer from 3 to 500,
R⁵ represents —OH or —OMe, preferably —OH;
a is a number from 0.05 to 0.25, such that (100×a) represents the molar percentage of units having the formula (I′) within the polymer (P).

Preferably, the units having the formula (II) of the polymer (P) have the following formula (II′):

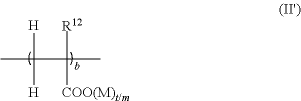

in which:
R¹² represents a hydrogen or a methyl, preferably a hydrogen;
M represents H or a cation of valency m;
when M represents H, m represents 1, and when M represents a cation, m is the valency of the cation M;
b is a number from 0.75 to 0.95, such that (100×b) represents the molar percentage of units having the formula (II′) within the polymer.

Preferably, the polymer (P) comprises units having the formulae (I′) and (II′).

The following embodiments for the formulae (I′) and (II′) of the polymer (P) may be considered independently or combined with one another:
q represents an integer from 5 to 200, in particular from 10 to 100, preferably from 25 to 75;
R⁵ represents —OH or —OMe, preferably R⁵ represents —OH;
a is a number from 0.05 to 0.20, preferably a represents a number between 0.10 and 0.20;
b is a number from 0.80 to 0.95, preferably b represents a number between 0.80 and 0.90;
the sum of a and b is 1 (which implies that the polymer is constituted of units having the formulae (I) and (II)); and/or
M represents H or a monovalent or bivalent cation, with m then representing 1 or 2, the monovalent cation preferably being selected from among an ammonium salt NH4⁺, a primary, secondary, tertiary or quaternary ammonium cation and a cation of an alkali metal, such as a sodium, lithium or potassium ion, and the divalent cation preferably being a cation of an alkaline earth metal, such as a magnesium or calcium ion.

The polymer (P) may comprise one or more additional unit(s) in addition to those having the formula (I) and (II). Preferably, the polymer (P) is free of units having the following formula (III):

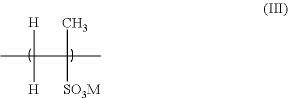

in which M represents H or a cation, such as sodium. In a particularly preferable manner, the polymer (P) is free of sulphonic acid and sulphonate groups.

Preferably, the polymer (P) is constituted of units having the formulae (I) and (II). It does not comprise any additional unit in addition to those having the formula (I) and (II). The sum of a and b is then 1.

The weight average molar mass of the polymer is generally from 10,000 to 200,000 g/mol, in particular from 10,000 to 100,000 g/mol.

Generally, the polymer (P) is obtained by means of free radical polymerisation.

The polymer (P) is therefore a comb polymer wherein the pendent groups are linked to the main carbon chain by ether groups.

The hydraulic binder composition (HBC) may also comprise polyalkoxylated polyphosphonate based polymers, preferably in a proportion of between 0.1 and 3.0% by dry weight relative to the total weight of hydraulic binder, optionally comprising mineral additives, preferably in a proportion from 0.3 to 1.0% by dry weight, in particular as described in the patent EP0663892 (for example CHRYSO®Fluid Optima 100).

In the context of the present invention, the polyalkoxylated phosphonate is preferably a polyalkoxylated phosphonate polymer having the formula (V) or one of the salts thereof, alone or as a mixture:

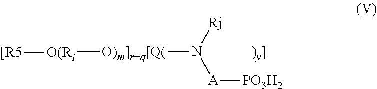

in which:
R5 is a hydrogen atom or a monovalent hydrocarbon group containing from 1 to 18 carbon atoms and optionally one or more heteroatoms;
the Ri are similar or different from each other and represent an alkylene such as ethylene, propylene, butylene, amylene, octylene or cyclohexene; or an arylene such as styrene or methylstyrene; the Ri optionally contain one or more heteroatoms;
Q is a hydrocarbon group containing from 2 to 18 carbon atoms and optionally one or more heteroatoms;
A is an alkylidene group containing from 1 to 5 carbon atoms; the Rj are similar or different from each other and may be selected from among:
   the group A-PO₃H₂, A having the previously noted definition;
   the alkyl group containing from 1 to 18 carbon atoms and optionally bearing the groups [R⁵—O(Rᵢ—O)ₘ], R5 and Ri having the previously noted definitions;
      “m” is a number greater than or equal to 0;
      “r” is the number of the groups [R⁵—O(Rᵢ—O)ₘ] borne by all of the Rj;
      “q” is the number of the groups [R⁵—O(Rᵢ—O)ₘ]] borne by Q;
      the sum of “r+q” is between 1 and 10;
      “y” is an integer between 1 and 3;
      Q, N and the Rⱼ's may together form one or more rings, with the one or more rings possibly also containing one or more other heteroatoms.

In a particularly preferable manner, the polyalkoxylated phosphonate is constituted of a water-soluble or water-dispersible organic compound comprising at least one amino-di-(alkylene-phosphonic) group and at least one polyoxyalkylated chain or at least one of the salts thereof.

Preferably, the polyalkoxylated phosphonate is a compound having the formula (V) in which:
R⁵ is a hydrogen atom or a monovalent hydrocarbon group, either saturated or un saturated, containing from 1 to 8 carbon atoms and optionally one or more heteroatoms;
the Ri represent ethylene or propylene or a mixture of ethylene or propylene, preferably 60 to 100% of the Rᵢ are ethylene groups;
Q is a hydrocarbon group containing from 2 to 8 carbon atoms and, optionally, one or more heteroatoms;
A is the methylene group;
each of the Rj represents the group CH₂—PO₃H₂;
m is an integer between 10 and 250;
q is an integer equal to 1 or 2;
y is an integer equal to 1 or 2.

In particular, the polyalkoxylated phosphonate may be a polyalkoxylated phosphonate having the formula (V) in which R5 is a methyl group, the Rᵢ are ethylene and propylene groups, m being between 30 and 50, r+q equals to 1, Q is an ethylene group, A is a methylene group, y equals to 1, and Rⱼ corresponds to the group CH₂—PO₃H₂.

Preferably the hydraulic binder composition (HBC) according to the invention comprises from 0 to 3.0% by dry weight of polymer (P), preferably from 0 to 1% by dry weight of polymer (P), relative to the total weight of hydraulic binder.

The present patent application also relates to the use of nitric acid or a salt thereof, other than zinc nitrate, as defined above, for the preparation of a hydraulic binder composition as defined above, or for the preparation of a hydraulic composition as defined above, by the addition of: nitric acid or a salt thereof to a hydraulic binder composition comprising a hydraulic binder as defined above or to a composition comprising a hydraulic binder as defined above, water and optionally at least one aggregate.

The use according to the invention makes it possible to enhance the fluidity retention of the hydraulic compositions as compared to the same hydraulic composition when it does not contain nitric acid or a salt thereof.

The present invention also relates to the use of the hydraulic binder composition (HBC) defined above for the preparation of a hydraulic composition (HC).

The invention also relates to a hydraulic composition (HC) comprising (or indeed even constituted of) the hydraulic binder composition (HBC) defined above, water, and optionally at least one aggregate.

The present invention relates to a hydraulic composition (HC) comprising:
a hydraulic binder comprising at least one alumino-silicate compound, preferably blast furnace slag, and an alkaline or sulphate activator, and a maximum of 10% by weight of clinker, preferably between 0 and 10% by weight of clinker, and optionally, mineral additives as described above;
water;
optionally at least one aggregate;
nitric acid or a salt thereof, other than zinc nitrate.

The alumino-silicate compound, the activator and the mineral additives being as defined above.

The hydraulic composition may also comprise a polymer (P) as defined above.

The hydraulic binder, the nitric acid and salts thereof, the activator, the mineral additives, as well as the polymer (P) are as defined above.

The hydraulic composition may also comprise a polyalkoxylated polyphosphonate based polymer, preferably in a proportion of between 0.1 and 3.0% by dry weight relative to the total weight of hydraulic binder, preferably from 0.3 to 1.0% by dry weight. This polymer is as described above.

The amount of nitric acid or a salt thereof in the hydraulic composition is between 0.1 and 5% by dry weight, preferably between 1.0 and 2.5% by dry weight, relative to the total weight of hydraulic binder. Preferably, the amount of nitric acid or a salt thereof in the hydraulic composition is between 0.1 and 1.5% by dry weight, relative to the total weight of hydraulic binder.

Preferably, the hydraulic composition comprises from 0 to 3.0% by dry weight of polymer (P), preferably from 0 to 1.0% by dry weight of polymer (P), relative to the total weight of hydraulic binder.

The hydraulic composition is preferably a concrete, mortar or screed composition.

The term “aggregates” is used to refer to a set of mineral grains with an average diameter of between 0 and 125 mm. Depending on their diameter, the aggregates are classified into one of the following six families: fillers, grit, sand, gravel, crushed stone and ballast (French standard XP P 18-545). The most commonly used aggregates are:
fillers, which have a diameter of less than 2 mm and for which at least 85% of the aggregates have a diameter of less than 1.25 mm and at least 70% of the aggregates have a diameter of less than 0.063 mm;
sands having a diameter of between 0 and 4 mm (in the standard 13-242, the diameter may go up to 6 mm);
gravel having a diameter greater than 6.3 mm;
crushed stone having a diameter of between 2 mm and 63 mm.
   Sands are therefore included in the definition of aggregate according to the invention. The fillers may, as to origin, be derived in particular from limestone or dolomite.

Other additives may also be added to the hydraulic composition (HC) according to the invention, such as anti-air entrainment additives, anti-foaming agents, a curing accelerator or retarder, a rheology modifier, or another fluidifier (“plasticiser” or “superplasticiser”).

The present patent application also relates to a process for preparing a hydraulic composition according to the invention, in which the nitric acid or a salt thereof, other than zinc nitrate, the optional polymer (P), and the optional polyalkoxylated polyphosphonate based polymer, are added to the hydraulic binder.

The present patent application also relates to a process for preparing a hydraulic composition according to the invention, in which the nitric acid or a salt thereof, other than zinc nitrate, the optional polymer (P), and the optional polyalkoxylated polyphosphonate based polymer, are added with water, for example to the mixing water.

The hydraulic compositions are prepared in a conventional manner by mixing the aforementioned constituents. The polymer (P) according to the invention, and where appropriate the polyalkoxylated polyphosphonate based polymer, may be added to the components of the hydraulic composition in dry form (generally in powder form) or in a solution, preferably in an aqueous solution. The water in the said aqueous solution may be the mixing water or the pre-wetting water (part of the total water which is used to wet the aggregates prior to the mixing, thus making it possible to simulate the hygrometric state of the aggregates, which are often wet, in a concrete plant or on the construction site.

The present invention also relates to the use of nitric acid or a salt thereof, other than zinc nitrate, for the preparation of a hydraulic composition comprising a hydraulic binder that comprises at least one alumino-silicate compound, preferably blast furnace slag, and an alkaline or sulphate activator, and a maximum of 10% by weight of clinker, preferably between 0 and 10.0% by weight of clinker, and optionally mineral additives as described above, water, and optionally at least one aggregate.

The hydraulic binder, the nitric acid and salts thereof, the activator, and the mineral additives, are as defined above.

The present invention also relates to the use of nitric acid or a salt thereof, other than zinc nitrate, in order to enhance the fluidity, in particular the retention of workability, of a hydraulic composition comprising at least one alumino-silicate compound, preferably blast furnace slag, and an alkaline or sulphate activator, and a maximum of 10% by weight of clinker, preferably between 0 and 10.0% by weight of clinker, and optionally mineral additives as described above, water, and optionally at least one aggregate.

The hydraulic binder, the nitric acid and salts thereof, the activator, and the mineral additives, are as defined above.

The amount of nitric acid or salts thereof added to the hydraulic composition is between 0.1 and 5% by dry weight, preferably between 0.5 and 1.5% by dry weight, relative to the total weight of hydraulic binder.

Preferably, the amount of polymer (P) added to the hydraulic composition where appropriate is between 0.1 and 3.0% by dry weight of polymer (P), preferably from 0.3 to 1.0% by dry weight of polymer (P), relative to the total weight of hydraulic binder.

In an advantageous manner, the said use according to the invention provides the means for enhancing the retention of fluidity (also referred to as retention of workability) over time, of the hydraulic composition, as compared to the same hydraulic composition when it does not contain the nitric acid or salts thereof. This enhancement in the retention of fluidity is as described above and makes it possible to obtain mechanical strength values at 24 hours that are of the same order of magnitude as a control which does not use the solution.

In an advantageous manner, a polyalkoxylated polyphosphonate based polymer as described above may also be added, in particular in the proportions as mentioned above.

The present invention also relates to a process for enhancing the retention of fluidity (also referred to as retention of workability) over time of a hydraulic composition comprising a hydraulic binder that comprises at least one alumino-silicate compound, preferably blast furnace slag, an alkaline or sulphate activator, and a maximum of 10% by weight of clinker, preferably between 0 and 10.0% by weight of clinker, and optionally mineral additives as described above, water, and optionally at least one aggregate; which includes the adding of nitric acid or a salt thereof, other than zinc nitrate, as defined above.

This enhancement in the retention of fluidity is as described above.

The hydraulic binder is as defined above.

Preferably, the process according to the invention includes the adding of 0.1 to 5% by dry weight, preferably from 1.0% to 2.5% by dry weight, relative to the total weight of hydraulic binder, of nitric acid or a salt thereof. Preferably, the process according to the invention includes the adding of 0.1 to 1.5% by dry weight, relative to the total weight of hydraulic binder, of nitric acid or a salt thereof.

The process according to the invention may also include the adding of a polymer (P) as defined above.

Preferably, the process according to the invention includes the adding where appropriate of 0.1% to 3.0% by dry weight of polymer (P), preferably from 0.3 to 1.0% by dry weight of polymer (P), relative to the total weight of hydraulic binder.

The nitric acid and salts thereof, and the polymer (P) are as described above.

The activator and mineral additives are as described above.

The process of the invention may further include the adding of polyalkoxylated polyphosphonate based polymers, preferably in a proportion of between 0.1 and 3.0% by weight relative to the total weight of hydraulic binder, preferably from 0.3 to 1.0% by weight.

These polymers are as described above.

The nitric acid or salts thereof may be added to the hydraulic binder, and optionally the polymer (P) and the optional polyalkoxylated polyphosphonate based polymer is/are added in water, referred to as mixing water. The polymer (P) according to the invention, and where appropriate the polyalkoxylated polyphosphonate based polymer, may be added to the components of the hydraulic composition in dry form (generally in powder form) or in a solution, preferably in an aqueous solution. The water in the said aqueous solution may be the mixing water or the pre-wetting water (part of the total water which is used to wet the aggregates prior to the mixing, thus making it possible to simulate the hygrometric state of the aggregates, which are often wet, in a concrete plant or on the construction site.

The nitric acid or salts thereof as well as, where appropriate, the polymer (P), and the optional polyalkoxylated polyphosphonate based polymer may be added to the hydraulic binder.

The present invention will hereinafter be described making use of the examples below.

### Thixotropy and Fluidity Monitoring Tests on Mortar

The composition of all mortars is as follows, with only the composition of the binder changing depending on the specific case:

TABLE 1

| | |
|---|---|
| Binder (g) | 658.5 |
| Bernières Sand 0/4 mm (g) | 1265.6 |
| Water (g) | 263.4 |

The mortar was kept in a Perrier-type mixer running continuously at 43 revolutions per minute (rpm). Slump measurements using a 700 cm³ cone were carried out at 5 min and 25 min after the start of mixing: in order to do this, the mixer was stopped during the time it took to fill the cone, and then restarted.

Following 25 minutes of mixing and the measuring of slump, a quantity of mortar was placed in a plurality of sections of PVC pipe having a diameter of 44 mm and a height of 99 mm. The mortar was levelled and then a cover with a weighted mass mounted over it was added so as to prevent any evaporation or leakage of mortar from the bottom of the pipe.

At precise time intervals after being positioned in place, a pipe is lifted and the spread of the mortar resulting therefrom is measured. Eventually there comes a point in time when the mortar no longer flows and a cylinder reproducing the form of the pipe is obtained. This time instant is noted and the results are then expressed in terms of the elapsed time before obtaining this state.

### EXAMPLE 1—ACTIVATED BLAST FURNACE SLAG MORTARS

The composition of the binder is provided in the following table:

TABLE 2

| | |
|---|---|
| Crushed granulated blast furnace slag | 89.33% |
| Sodium Metasilicate | 8.00% |
| Sodium Carbonate | 2.67% |

The results obtained are as follows:

TABLE 3

| | | 0.72% Calcium |
|---|---|---|
| | Control | Nitrate |
| Spread 5 min (mm) | 250 | 275 |
| Spread 25 min (mm) | 225 | 270 |
| Thixotropic Recovery Time (min) | 50 | 65 |
| 24 h Compressive Strength, 20° C. (Mpa) | 23.5 | 21.4 |
| 24 h Compressive Strength, 30° C. (Mpa) | 34.1 | 29.8 |

It can be clearly noted that the admixed version exhibits greater spread values at 5 and 25 min, and a flow time before thixotropic hardening that is 15 min longer, while still retaining most of the mechanical strength, which decreases by 2 to 4 MPa depending on the temperature.

### EXAMPLE 2—SUPER-SULPHATED CEMENT MORTARS

The composition of the binder in this instance is as follows:

TABLE 4

| | |
|---|---|
| Crushed granulated blast furnace slag | 93% |
| Gypsum | 7% |

The results obtained are as follows:

TABLE 5

| | | 0.72% Calcium |
|---|---|---|
| | Control | Nitrate |
| Spread 5 min (mm) | 215 | 280 |
| Spread 25 min (mm) | 190 | 240 |
| Thixotropic Recovery Time (min) | 35 | 65 |
| 24 h compressive strength, 20° C. (MPa) | 9 | 8.4 |
| 24 h compressive strength, 30° C. (MPa) | 14.1 | 13.7 |

The spreads at 5 and 25 min are significantly increased as a result of implementing the invention. The time to thixotropic stiffening is also significantly increased from 35 to 65 min. All of the foregoing is achieved with very little effect on the mechanical strengths at the two temperatures.

### EXAMPLE 3—CEM III/C TYPE CEMENT MORTARS ACTIVATED BY AN ALKALINE COMPOUND

The composition of the binder is as follows:

TABLE 6

| | |
|---|---|
| Portland Cement | 5% |
| Crushed granulated blast furnace slag | 83% |
| Sodium Metasilicate | 12% |

The performance values obtained are as follows:

TABLE 7

| | | 0.72% Calcium | |
|---|---|---|---|
| | Control | Nitrate | 0.72% Nitric Acid |
| Spread 5 min (mm) | 250 | 260 | 260 |
| Spread 25 min (mm) | 240 | 250 | 255 |
| Thixotropic Recovery | 20 | 35 | 65 |
| Time (min) | | | |
| 24 h compressive | 26.8 | 20.9 | 18.7 |
| strength, 20° C. (MPa) | | | |
| 24 h compressive | 31.1 | 24.7 | 30.8 |
| strength, 30° C. (MPa) | | | |

The fluidity is slightly enhanced by using the invention, with spreads being slightly higher than the control and a slightly longer time to thixotropic stiffening equal to 15 min. The strength values are reduced by 5 to 7 MPa, but remain within an acceptable range.

1. Hydraulic binder composition comprising:
a hydraulic binder that comprises at least one alumino-silicate compound, and an alkaline or sulphate activator and a maximum of 10% by weight of clinker;
nitric acid or a salt thereof, the salt of nitric acid being other than zinc nitrate, the amount of nitric acid or a salt thereof being between 0.1 and 1.5% by dry weight, relative to the total weight of hydraulic binder.

2. A hydraulic composition (HC) comprising:
a hydraulic binder that comprises at least one alumino-silicate compound, and an alkaline or sulphate activator, and a maximum of 10% by weight of clinker, and optionally mineral additives;
water;
optionally at least one aggregate;
nitric acid or a salt thereof, the salt of nitric acid being other than zinc nitrate, the amount of nitric acid or a salt thereof being between 0.1 and 1.5% by dry weight, relative to the total weight of hydraulic binder.

3. (canceled)

4. A process for enhancing the retention of fluidity over time of a hydraulic composition comprising a hydraulic binder that comprises at least one alumino-silicate compound, and an alkaline or sulphate activator, and a maximum of 10% by weight of clinker, water, and optionally at least one aggregate; comprising the adding to the said hydraulic composition of nitric acid or a salt thereof, other than zinc nitrate, the amount of nitric acid or a salt thereof being between 0.1 and 1.5% by dry weight, relative to the total weight of hydraulic binder.

5. The hydraulic binder composition according to claim 1, wherein the nitric acid salt is selected from the group consisting of the salts of alkali or alkaline earth metals.

6. The hydraulic binder composition according to claim 1, wherein the activator is selected from a calcium activator or sulpho-calcium activator; or an alkaline salt.

7. The hydraulic binder composition according to claim 1, wherein the alumino-silicate compound is selected from among blast furnace slags, pozzolanic materials (as defined in the French standard Cement NF EN 197-1(2012) paragraph 5.2.3), fly ash (as defined in the French standard Cement NF EN 197-1(2012) paragraph 5.2.4), calcined schists (as defined in the French standard Cement NF EN 197-1 (2012) paragraph 5.2.5), metakaolins, such as type A metakaolins compliant with the French standard NF P 18-513 (August 2012) or calcined clays, alumino-silicates, alumino-silicates containing iron oxides such as bauxite residues, norites or aplites obtained from excavations.

8. The hydraulic binder composition according to claim 1, wherein the alumino-silicate compound is a blast furnace slag.

9. The hydraulic binder composition according to claim 1, wherein further comprising:
a polymer (P) comprising units having the following formulae (I) and (II): 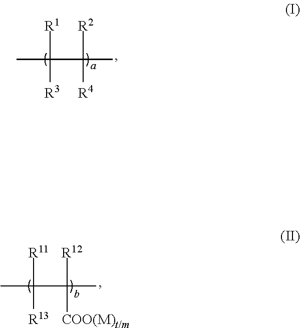
in which:
R¹ and R² independently represent a hydrogen or a methyl;
R³ represents a hydrogen or a group having the formula —COO(M)_{i/m};
R⁴ represents a group having the formula —(CH₂)ₚ—(OAlk)_{q}-R₅ in which:
p represents 1 or 2;
q represents an integer from 3 to 300;
the Alk of each OAlk unit of the group —(OAlk)_{q}-independently represents a linear or branched alkylene containing from 2 to 4 carbon atoms;
R⁵ represents —OH or a linear or branched alkoxyl containing from 1 to 4 carbon atoms;
R¹¹ and R¹² independently represent a hydrogen or a methyl;
R¹³ represents a hydrogen or a group having the formula —COO(M)_{1/m};
M represents H or a cation of valency m;
when M represents H, m represents 1, and when M represents a cation, m is the valency of the cation M;
a is a number from 0.05 to 0.25, such that (100×a) represents the molar percentage of units having the formula (I) within the polymer, and
b is a number from 0.75 to 0.95, such that (100×b) represents the molar percentage of units having the formula (II) within the polymer; and/or
polyalkoxylated polyphosphonate based polymers; or
anti-air entrainment additives, anti-foaming agents, a curing accelerator or retarder, a rheology modifying agent, a fluidifier.

10. A process for preparing a hydraulic composition according to claim 4, in which the nitric acid or a salt thereof, other than zinc nitrate, is added to the hydraulic binder.

11. The hydraulic composition according to claim 2, wherein the nitric acid salt is selected from the group consisting of the salts of alkali or alkaline earth metals.

12. The hydraulic composition according to claim 2, wherein the activator is selected from a calcium activator or sulpho-calcium activator; or an alkaline salt.

13. The hydraulic composition according to claim 2, wherein the alumino-silicate compound is selected from among blast furnace slags, pozzolanic materials (as defined in the French standard Cement NF EN 197-1(2012) paragraph 5.2.3), fly ash (as defined in the French standard Cement NF EN 197-1(2012) paragraph 5.2.4), calcined schists (as defined in the French standard Cement NF EN 197-1 (2012) paragraph 5.2.5), metakaolins, such as type A metakaolins compliant with the French standard NF P 18-513 (August 2012) or calcined clays, alumino-silicates, alumino-silicates containing iron oxides such as bauxite residues, norites or aplites obtained from excavations.

14. The hydraulic composition according to claim 2, wherein the alumino-silicate compound is a blast furnace slag.

15. The hydraulic composition according to claim 2, further comprising:
a polymer (P) comprising units having the following formulae (I) and (II): 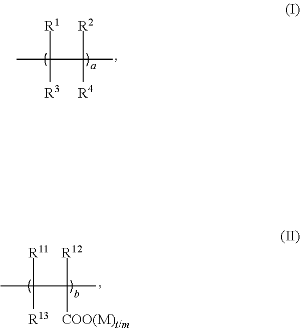
in which:
R¹ and R² independently represent a hydrogen or a methyl;
R³ represents a hydrogen or a group having the formula —COO(M)_{i/m};
R⁴ represents a group having the formula —(CH₂)ₚ—(OAlk)_{q}-R₅ in which:
p represents 1 or 2;
q represents an integer from 3 to 300;
the Alk of each OAlk unit of the group —(OAlk)_{q}-independently represents a linear or branched alkylene containing from 2 to 4 carbon atoms;
R⁵ represents —OH or a linear or branched alkoxyl containing from 1 to 4 carbon atoms;
R¹¹ and R¹² independently represent a hydrogen or a methyl;
R¹³ represents a hydrogen or a group having the formula —COO(M)_{1/m};
M represents H or a cation of valency m;
when M represents H, m represents 1, and when M represents a cation, m is the valency of the cation M;
a is a number from 0.05 to 0.25, such that (100×a) represents the molar percentage of units having the formula (I) within the polymer, and
b is a number from 0.75 to 0.95, such that (100×b) represents the molar percentage of units having the formula (II) within the polymer; and/or
polyalkoxylated polyphosphonate based polymers; or
anti-air entrainment additives, anti-foaming agents, a curing accelerator or retarder, a rheology modifying agent, a fluidifier.

16. The process according to claim 4, wherein the nitric acid salt is selected from the group consisting of the salts of alkali or alkaline earth metals.

17. The process according to claim 4, wherein the activator is selected from a calcium activator or sulpho-calcium activator; or an alkaline salt.

18. The process according to claim 4, wherein the alumino-silicate compound is selected from among blast furnace slags, pozzolanic materials (as defined in the French standard Cement NF EN 197-1(2012) paragraph 5.2.3), fly ash (as defined in the French standard Cement NF EN 197-1(2012) paragraph 5.2.4), calcined schists (as defined in the French standard Cement NF EN 197-1 (2012) paragraph 5.2.5), metakaolins, such as type A metakaolins compliant with the French standard NF P 18-513 (August 2012) or calcined clays, alumino-silicates, alumino-silicates containing iron oxides such as bauxite residues, norites or aplites obtained from excavations.

19. The process according to claim 4, wherein the alumino-silicate compound is a blast furnace slag.

20. The process according to claim 4, wherein the hydraulic composition further comprises:
a polymer (P) comprising units having the following formulae (I) and (II): 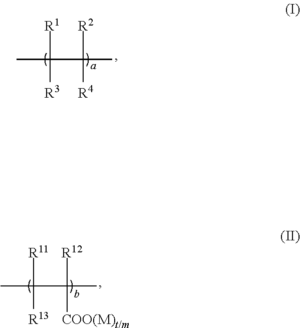
in which:
R¹ and R² independently represent a hydrogen or a methyl;
R³ represents a hydrogen or a group having the formula —COO(M)_{i/m};
R⁴ represents a group having the formula —(CH₂)ₚ—(OAlk)_{q}-R₅ in which:
p represents 1 or 2;
q represents an integer from 3 to 300;
the Alk of each OAlk unit of the group —(OAlk)_{q}-independently represents a linear or branched alkylene containing from 2 to 4 carbon atoms;
R⁵ represents —OH or a linear or branched alkoxyl containing from 1 to 4 carbon atoms;
R¹¹ and R¹² independently represent a hydrogen or a methyl;
R¹³ represents a hydrogen or a group having the formula —COO(M)_{1/m};
M represents H or a cation of valency m;
when M represents H, m represents 1, and when M represents a cation, m is the valency of the cation M;
a is a number from 0.05 to 0.25, such that (100×a) represents the molar percentage of units having the formula (I) within the polymer, and
b is a number from 0.75 to 0.95, such that (100×b) represents the molar percentage of units having the formula (II) within the polymer; and/or
polyalkoxylated polyphosphonate based polymers; or
anti-air entrainment additives, anti-foaming agents, a curing accelerator or retarder, a rheology modifying agent, a fluidifier.
